(19) United States
(12) Patent Application Publication
(10) Pub. No.: US 2007/0091943 A1
(43) Pub. Date: Apr. 26, 2007

(54) Light source module

(76) Inventors: Andrew L. Van Brocklin, Corvallis, OR (US); Kuohua Wu, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/255,653

(22) Filed: Oct. 20, 2005

(51) Int. Cl. H01S 3/10

(52) U.S. Cl. 372/21; 372/1

(57) ABSTRACT

A light source module includes a laser configured to generate infrared light, and a harmonic generating crystal is in optical communication with the laser. According to one exemplary embodiment, the harmonic generating crystal has a periodicity selected to provide a maximum output at an initial temperature. An actuator is coupled to the harmonic generating crystal and is configured to apply a restoring force to the harmonic generating crystal to maintain said periodicity over a temperature range.

### BACKGROUND

Display systems display an image or series of images on a display surface. In particular, each image is frequently made up of several sub-images. For example, some systems produce multiple component beams that are modulated to produce corresponding component sub-images. The sub-images are then combined to form a single, full-color image.

Recent designs have made use of lasers to provide the multiple component beams. Lasers frequently allow for the formation of relatively bright images. However, lasers configured to generate light in the visible spectrum may be relatively more expensive that lasers configured to generate other types of light, such as light in the infrared region. The frequency of this light may then be multiplied, such as doubled, to produce the multiple component beams.

The frequency of the light is multiplied by the use of harmonic generating crystal. Harmonic generating crystals often include alternating or grated bands of material with alternating polarities. Such a configuration may be referred to as a periodically poled crystal, as the polarities or “poles” alternate at a regular or periodic interval. When light is incident on a frequency doubling crystal, the non-symmetry at the interfaces between bands changes the frequency.

The periodic variation of polarity of the frequency doubling crystal relative to the crystal length may be called periodicity. By properly controlling the periodicity, the frequency of a given wavelength of light incident on the crystal can be multiplied. For example, the frequency may be doubled. Doubling the frequency cuts the wavelength of the light in half.

As the light source operates, the crystal is heated. The crystal will expand due to this heating. As the crystal expands, the periodicity also increases. As introduced, the periodicity controls how the frequency of light incident on the crystal is changed. Accordingly, many crystals are designed to operate at a steady elevated temperature. Such designs are operable once the crystal reaches the desired elevated operating temperature. The time delay experienced as the crystal is heated may be in the range of several seconds to several minutes.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a schematic view of a display system according to one exemplary embodiment.

FIG. 2 illustrates a schematic view of a light source module according to one exemplary embodiment.

FIG. 3 is a flowchart illustrating a method of generating light according to one exemplary embodiment.

FIG. 4 is a flowchart illustrating a method of maintaining periodicity according to one exemplary embodiment.

FIG. 5 illustrates a light source module according to one exemplary embodiment.

FIG. 6 illustrates a light source module according to one exemplary embodiment.

Throughout the drawings, identical reference numbers designate similar, but not necessarily identical, elements.

### DETAILED DESCRIPTION

An illumination system is provided herein for use in display systems. According to one exemplary embodiment, the display system includes an illumination system, a light modulator assembly, and display optics. The illumination system includes at least one light source, such as one or more lasers. For example, according to one exemplary embodiment, each light source includes a laser, a harmonic generating crystal coupled to the laser, such as a frequency doubling crystal, and an actuator coupled to the harmonic generating crystal. The harmonic generating crystal has a periodicity selected to provide substantially maximum output at an initial temperature. The ability to provide an acceptable output while minimizing a heating up period of the crystal may be referred to as instant-on functionality. As the light source module is operated, the harmonic generating crystal is heated. As the generating crystal is heated, it tends to expand in all directions, including the length. If not countered, this tendency increases the length including the periodicity of the harmonic generating crystal. Such a configuration may allow the laser light source to provide suitable light in a substantially instant-on configuration and maintain the output of the light source module at an acceptable level over a range of temperatures.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. Although the phrase, “in one embodiment” appears in various places in the specification, each appearance of the phrase does not necessarily refer to the same embodiment.

Display System

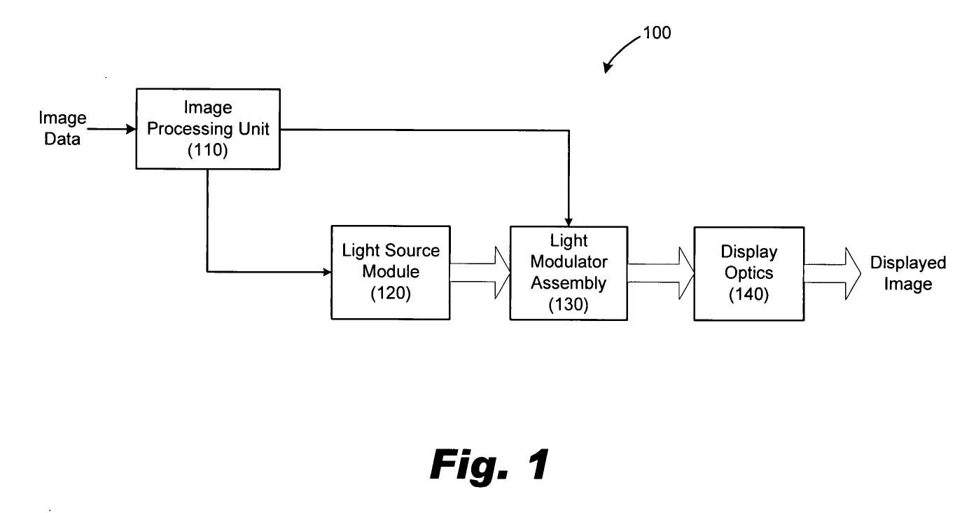

FIG. 1 is a schematic view of a display system (100) according to one exemplary embodiment. The components of FIG. 1 are exemplary only and may be modified or changed as best serves a particular application. As shown in FIG. 1, image data is input into an image processing unit (110). The image data defines an image that is to be displayed by the display system (100).

While one image is illustrated and described as being processed by the image processing unit (110), it will be understood by one skilled in the art that a plurality or series of images may be processed by the image processing unit (110). The image processing unit (110) performs various functions including controlling the illumination of a light source module (120) and controlling a light modulator assembly (130).

The light source module (120) includes at least one light source. According to one exemplary embodiment, the light source module includes one or more coherent light sources, such as one or more lasers. At least one laser is configured to generate light in the infrared region. A harmonic generating crystal is associated with each such laser. The harmonic generating crystal modifies the frequency of light directed thereto. For example, according to one exemplary embodiment, the harmonic generating crystal produces a second order harmonic response, thereby doubling the frequency of light directed thereto to produce light in the visible spectrum.

The light source module (120) is also able to provide substantially instant-on response. For example, the harmonic generating crystal is able to provide full output at an initial temperature, such as room temperature. More specifically, the periodicity of the harmonic generating crystal is established to double the frequency of the incident light at the initial temperature. As the harmonic generating crystal is heated, it tends to expand. As the harmonic generating crystal expands, the periodicity of the harmonic generating crystal also increases. An increase in the periodicity may reduce the ability of the harmonic generating crystal to double the frequency of light at the given frequency, and thus to produce light in the visible spectrum.

An actuator is coupled to the harmonic generating crystal. As the crystal is heated, the actuator selectively applies a restoring force to the harmonic generating crystal. According to one exemplary embodiment, the restoring force compresses the harmonic generating crystal by a sufficient amount to maintain the periodicity of the harmonic generating crystal substantially constant. As the actuator maintains the periodicity, the actuator helps ensure that the harmonic generating crystal functions properly and the light output from the light source module is maximized.

The light from each of the light sources is directed to the light modulator assembly (130). The light incident on the light modulator assembly (130) may be modulated in its phase, intensity, polarization, or direction by the light modulator assembly (130) to form substantially full images or sub-images. The light modulated by the light modulator assembly (130) is then directed to display optics (140).

The display optics (140) may include any device configured to display or project an image. For example, the display optics (140) may be, but are not limited to, a lens configured to project and focus an image onto a viewing surface. The viewing surface may be, but is not limited to, a screen, a television such as a rear projection-type television, wall, liquid crystal display (LCD), or computer monitor.

Light Source Module

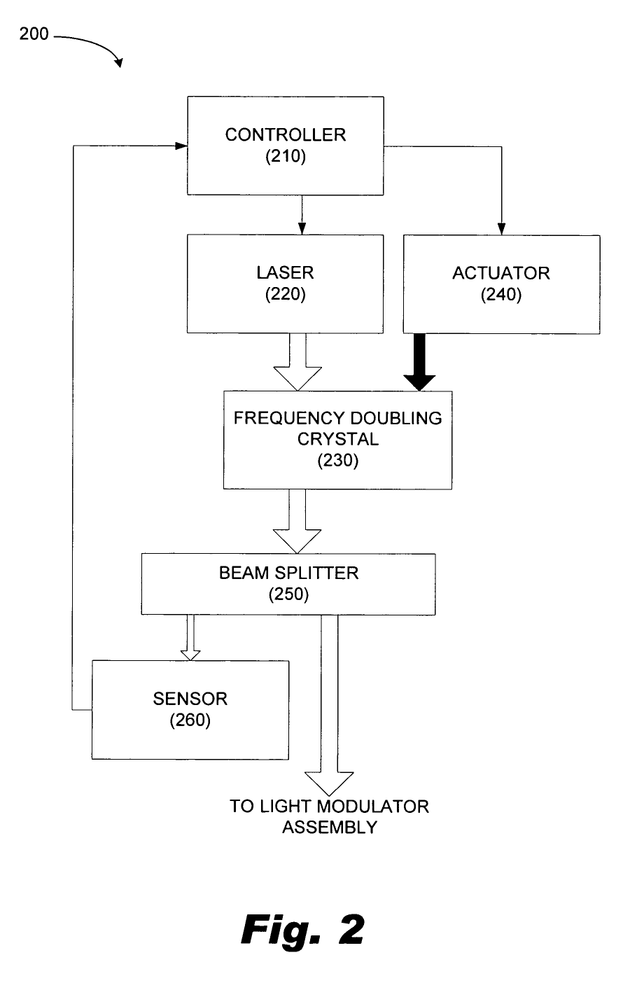

FIG. 2 illustrates a schematic view of a light source module (200) according to one exemplary embodiment. The light source module (200) generally includes a controller (210), a laser (220), a frequency doubling crystal (230), an actuator (240), a beam splitter (250) and a sensor (260). As will be discussed in more detail below, such a configuration allows the light source module (200) to provide substantially instant-on response using readily available lasers.

The controller (210) is coupled to the laser (220). For ease of reference, a single laser (220), frequency doubling crystal (230), and actuator (240) are described herein. Those of skill in the art will appreciate that any number of these components may be used. The laser (220) according to the present exemplary embodiment may be configured to generate a substantially constant beam of light, or the laser (220) may be configured to generate a pulsed beam of light. In either case, the laser (220) according to the present exemplary embodiment is configured to generate light in the infrared spectrum. The infrared light generated by the laser (220) is directed to the frequency doubling crystal (230).

The frequency doubling crystal (230) then doubles the frequency of light incident thereon. In particular, the periodicity of the frequency doubling crystal (230) according to the present exemplary embodiment is selected to double the frequency of the infrared light of the frequency and half the wavelength generated by the laser (220). Doubling the frequency of the infrared light produces light of a desired frequency and wavelength in the visible spectrum. Further, as previously introduced, while a frequency doubling crystal (230) is discussed herein, those of skill in the art will appreciate that any type of harmonic generating crystal may be used.

As previously discussed, the periodicity of the frequency doubling crystal (230) may be selected to generate a second harmonic response at an initial, lower temperature. As the frequency doubling crystal (230) is heated, it tends to expand in size. As the frequency doubling crystal (230) expands, the periodicity tends to increase.

The actuator (240) selectively applies a restoring force to counteract the expansion of the frequency doubling crystal (230). As the actuator (240) selectively applies the restoring force to the frequency doubling crystal (230), the actuator (240) maintains the periodicity substantially constant.

The magnitude of the restoring force applied by the actuator (240) may depend on several factors. For example, the rate at which a given material expands in response to an increase in temperature depends, at least in part, on the magnitude of the temperature difference and the coefficient of thermal expansion. The present light source module (200) is configured to automatically adjust the restoring force to maintain the periodicity at an appropriate value and to maximize light output.

In particular, the secondary harmonic response produced by the frequency doubling crystal (230) is conveyed to the beam splitter (250). The beam splitter (250) directs a portion of the visible light to the sensor (260) and the remainder of the visible light to a light modulator assembly.

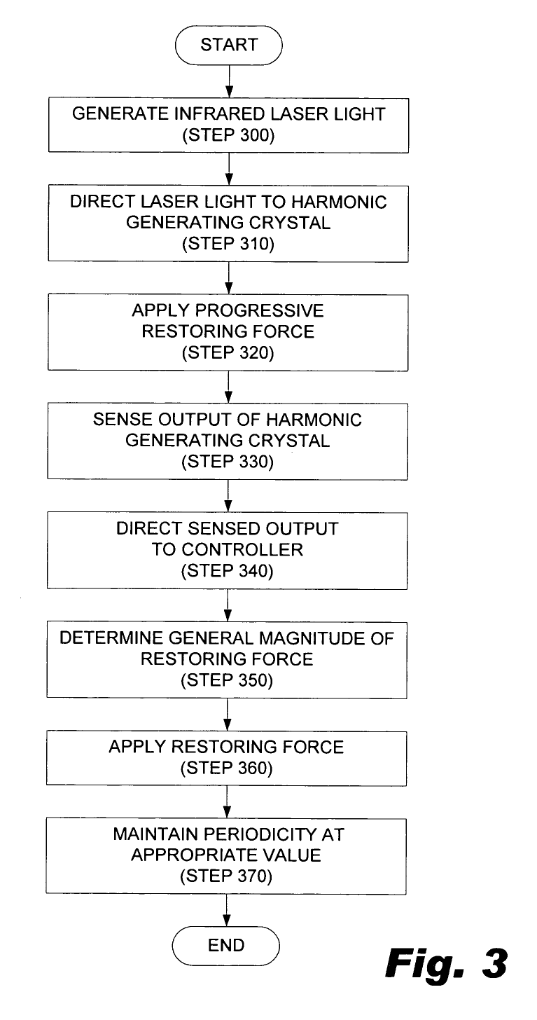

The sensor (260) senses the magnitude and/or other characteristics of the visible light. This information is then conveyed back to the controller (210). The controller then analyzes the information to determine the magnitude of the restoring force to be applied by the actuator (240) to maintain the periodicity of the frequency doubling crystal (230). Thus, the sensor (260) provides feedback about the performance of the laser (220) and the frequency doubling crystal (230) which the controller (210) uses to operate the light source. One such process is illustrated in FIG. 3.

Method of Generating Light

FIG. 3 illustrates a flowchart of a method of generating light according to one exemplary embodiment. The method begins by generating at least one beam of infrared laser light (step 300). For ease of reference, the discussion will continue with reference to a single laser. Those of skill in the art will continue to appreciate that any number of lasers may be used.

The laser light is then directed to a harmonic generating crystal, such as the frequency doubling crystal previously discussed (step 310). The harmonic generating crystal may be at any temperature within its operating range. At this point, the harmonic generating crystal may be at or near the temperature corresponding to the periodicity at which the harmonic generating crystal produces the harmonic generating response.

A controller then causes a progressive restoring force to be applied (step 320) to vary the output of the harmonic generating crystal. In particular, the controller may direct the actuator to apply an initial force to the harmonic generating crystal. The initial force may then be increased either incrementally or at a constant rate until the actuator has applied a predetermined maximum force to the harmonic generating crystal. In particular, according to one exemplary embodiment discussed in more detail below, the actuator may include a piezoelectric stack. According to such an embodiment, the progressive restoring force may be applied by sweeping the voltage to the piezoelectric stack.

As the actuator applies the progressive restoring force, a sensor senses the output of the harmonic generating crystal (step 330). This output is directed to the controller (step 340). The controller then analyzes the output of the harmonic generating crystal to determine a general magnitude of the restoring force (step 350). The controller then applies a restoring force of such a magnitude (step 360).

Thereafter, the controller continues to control the magnitude of the compressive force to help ensure the applied restoring force maintains the periodicity of the harmonic generating crystal at an appropriate value (step 370), such as when the crystal changes temperature due to heating or cooling. One such method is discussed in more detail below.

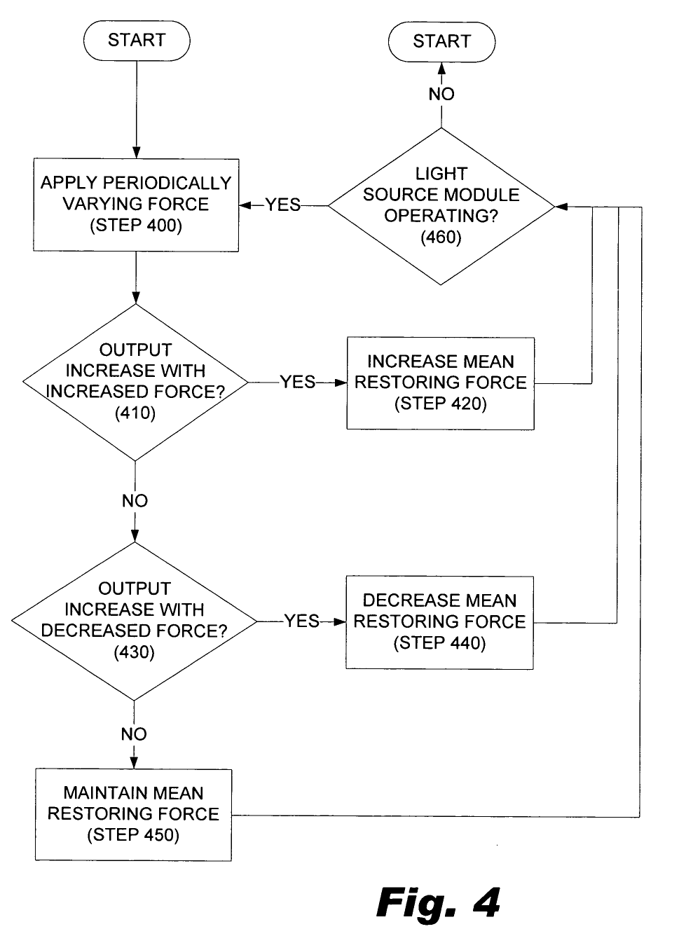

FIG. 4 is a flowchart illustrating a method of maintaining the periodicity of a harmonic generating crystal. The method begins once the controller has established an initial restoring force on the harmonic generating crystal. Thereafter, according to one exemplary method, the controller periodically applies a relatively small monitoring force or input in addition to or on top of the restoring force to the harmonic generating crystal (step 400). The input is sufficiently small to be substantially imperceptible to a viewer while providing sufficient feedback for controlling the output. For example, the variation of the input allows the controller to determine whether the restoring force should be increased or decreased to maintain the periodicity of the harmonic generating crystal.

In particular, as a sinusoidal input is applied the restoring force will periodically vary about a mean restoring force, between a slight increase in the restoring force and a slight decrease in the mean restoring force. If the output of the harmonic generating crystal increases with the increased restoring force (YES, determination 410), then the mean applied restoring force may be too weak. If the controller determines the restoring force is too weak, then the controller increases the mean restoring force (step 420).

If the controller determines that the output of the harmonic generating crystal does not increase with an increased restoring force (NO, determination 410), the controller then determines whether the output of the harmonic generating crystal increases with a decrease in restoring force (determination 430). If the output increases with a decrease in restoring force (YES, determination 430), then the controller determines the median restoring force is too high and decreases the median restoring force (step 440). If the output does not increase by increasing the restoring force (NO, determination 410) or decreasing the restoring force (NO, determination 430), then the mean restoring force is appropriate, and the median restoring force is maintained (step 450). Thereafter, while the light source module continues to operate (YES, determination 460), the controller continues to cause an input signal to be applied while monitoring the output of the harmonic generating crystal. Thus, the present method provides for the monitoring and maintenance of the periodicity of the harmonic generating crystal across a range of temperatures. The restoring force may be applied by any suitable actuator. Two exemplary actuators will be discussed in more detail.

Light Source Module having a Piezoelectric Actuator

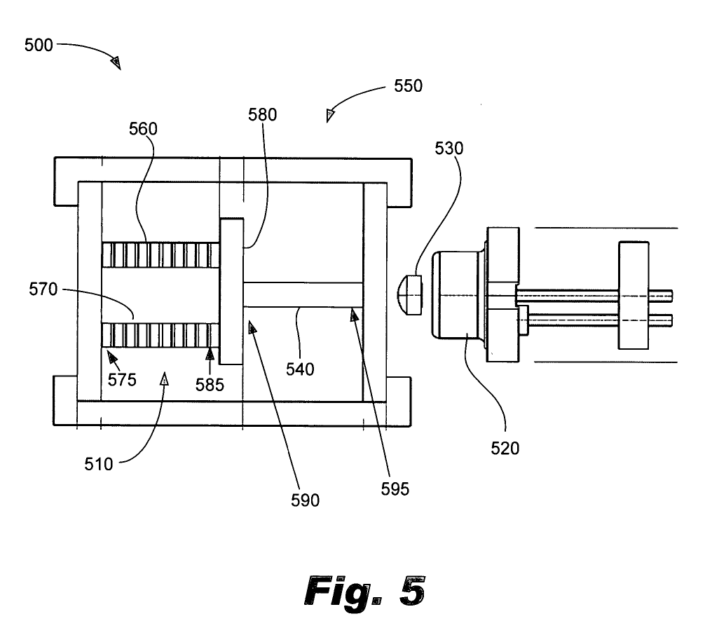

FIG. 5 illustrates a light source module (500) having a piezoelectric actuator (510). The light source module (500) also includes a laser (520), a collimator (530), a frequency doubling crystal (540), and a clamping assembly (550). As will be discussed in more detail below, the light source module (500) is configured to provide substantially instant-on functionality with the use of readily available lasers.

The laser (520) according to the present exemplary embodiment is a diode laser configured to generate infrared light. Any suitable laser may be used to generate the infrared light. For example, according to one exemplary embodiment, the laser is a GaAs diode laser configured to generate light with a wavelength of 860 nm or 1100 nm. Such lasers may produce relatively diffuse light.

The collimator (530) collimates the light produced by the laser (520) and directs the light to the frequency doubling crystal (540). Any suitable frequency doubling crystal (540) may be used. For example, according to one exemplary embodiment, the frequency doubling crystal (540) is a periodically poled lithium niobate crystal. Further, the lithium niobate crystal is sized to double the frequency of the infrared light incident thereon. According to one exemplary embodiment, the frequency doubling crystal (540) is about 5 mm long with a substantially square end face having dimensions of about 1 mm by about 1 mm.

The frequency doubling crystal (540) is configured to double the frequency of infrared light over a temperature range of about 5 degrees Celsius to about 65 degrees Celsius. The periodicity of the frequency doubling crystal (540) may be optimized for any initial temperature. For ease of reference, the periodicity of the frequency doubling crystal (540) will be discussed as being optimized for an initial temperature of about 5 degrees. Thus, at the initial temperature, the output of the frequency doubling crystal (540) may be maximized when infrared light of the selected frequency is directed thereto. Accordingly, when the light source module (500) is activated, the output may substantially instantly be at an acceptable level. Thus, the light source module (500) provides instant-on functionality.

As previously discussed, as the light source module (500) operates, the frequency doubling crystal (540) will heat up. As the crystal heats up, the crystal has a tendency to expand. In particular, a 5 mm long crystal will change in size at a ratio related to the change in temperature multiplied by the coefficient of thermal expansion. For a change in temperature of 60 degrees Celsius and for a lithium niobate crystal with a coefficient of thermal expansion of about 0.000017/° C. the strain will be about 0.00096.

The piezoelectric actuator (510) provides a restoring force to counter the strain induced by the expansion of the frequency doubling crystal (540) due to temperature changes. In particular, the stress required to counteract this strain is the product of the strain multiplied by the Young's Modulus. Lithium niobate crystal has a Young's Modulus of approximately 203 GPa. Accordingly, the maximum stress corresponding to the thermally-induced strains is about 194.9 MPa. For a 1 mm×1 mm end face on the 5 mm long crystal, the maximum restoring force required to maintain periodicity is the product of the area of the end face multiplied by the maximum stress, which corresponds to a maximum restoring force of about 194.9 N. Thus, according to the present exemplary embodiment, the piezoelectric actuator (510) provides a restoring force greater than about 200 N. For example, according to one exemplary embodiment, the piezoelectric actuator (510) is rated to provide a restoring force of about 700 N.

The piezoelectric actuator (510) expands to provide the restoring force. In particular, the piezoelectric actuator (510) includes first and second piezoelectric stacks (560, 570). These piezoelectric stacks (560, 570) are coupled on first ends (575) to the clamping assembly (580) and on second ends (585) to a coupling member (580). The coupling member (580) is in turn coupled to a first end (590) of the frequency doubling crystal (540). A second end (595) of the frequency doubling crystal (540) is coupled to the clamping assembly (550).

The first and second piezoelectric stacks (560, 570) expand to provide the restoring force. More specifically, as the piezoelectric stacks (560, 570) expand, the clamping assembly (580) minimizes movement of the first ends (575) of the piezoelectric stacks (560, 570) and the second end (595) of the frequency doubling crystal (540). Thus, as the piezoelectric stacks (560, 570) expand, the coupling member (580) is driven away from the piezoelectric stacks (560, 570). As the coupling member (580) is thus driven, the frequency doubling crystal (540) is compressed. This compression is controlled to thereby apply the restoring force previously discussed. As the piezoelectric stacks (560, 570) expand, a compressive force is also established in the piezoelectric stacks (560, 570). Other configurations are possible, such as light source module in which a tensile force is established in piezoelectric stacks (560, 570).

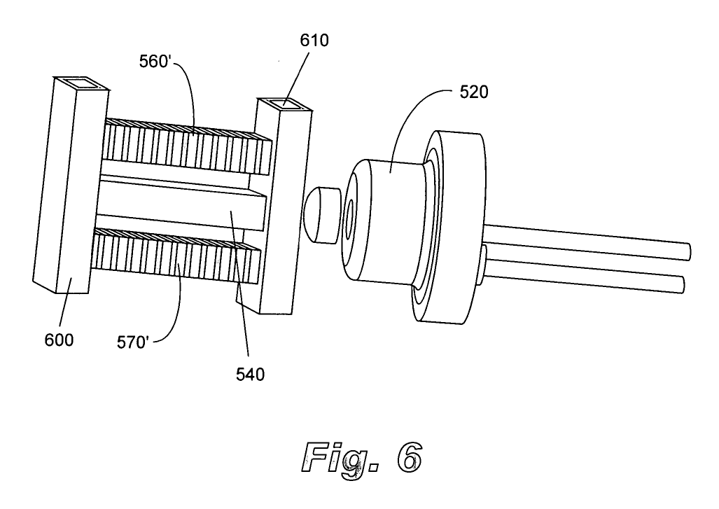

FIG. 6 illustrates a light source module (500′) which includes piezoelectric stacks (560′, 570′) located between opposing supports (600, 610). The piezoelectric stacks (560′, 570′) contract in response to an applied voltage. The piezoelectric stacks (560′, 570′) are coupled to each of the opposing supports (600, 610). As a result, the contraction of the piezoelectric stacks (560′, 570′) causes the opposing supports (600, 610) to be drawn together.

As shown in FIG. 6, the frequency doubling crystal (540) is coupled to each of the opposing supports (600, 610). Consequently, as the opposing supports (600, 610) are drawn together they compress the frequency doubling crystal (540), thereby applying a restoring force thereto. Accordingly, an actuator may either be expanded or contracted to provide a restoring force to the frequency doubling crystal (540).

In conclusion, an illumination system has been discussed herein for use in display systems. According to one exemplary embodiment, the display system includes an illumination system, a light modulator assembly, and display optics. The illumination system includes at least one light source, such as one or more lasers. For example, according to one exemplary embodiment, each light source includes a laser, a harmonic generating crystal coupled to the laser, such as a frequency doubling crystal, and an actuator coupled to the harmonic generating crystal. The harmonic generating crystal has a periodicity selected to provide substantially maximum output at an initial temperature. The ability to provide an acceptable output while minimizing a heating up period of the crystal may be referred to as instant-on functionality. As the light source module is operated, the harmonic generating crystal is heated. As the harmonic generating crystal is heated, it tends to expand in all directions, including the length. If not countered this tendency increases the length including the periodicity of the harmonic generating crystal. Such a configuration may allow the laser light source to provide suitable light in a substantially instant-on configuration and maintain the output of the light source module at an acceptable level over a range of temperatures.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A light source module, comprising:
a laser configured to generate infrared light;
a harmonic generating crystal in optical communication with said laser, said harmonic generating crystal having a periodicity selected to provide a maximum output at an initial temperature; and
an actuator coupled to said harmonic generating crystal, said actuator being configured to apply a restoring force to said harmonic generating crystal to maintain said periodicity over a temperature range.

2. The light source module of claim 1, wherein said laser comprises a diode laser.

3. The light source module of claim 2, wherein said diode laser includes a GaAs laser.

4. The light source module of claim 1, wherein said harmonic generating crystal comprises a frequency doubling crystal.

5. The light source module of claim 1, wherein said harmonic generating crystal comprises a periodically poled lithium niobate frequency doubling crystal.

6. The light source module of claim 1, wherein said actuator comprises at least one piezoelectric stack.

7. The light source module of claim 6, wherein said piezoelectric stack is configured to contract to apply said restoring force.

8. The light source module of claim 6, wherein said piezoelectric stack is configured to expand to provide said restoring force.

9. The source module of claim 1, and further comprising a collimator located at least partially between said harmonic generating crystal and said laser.

10. The light source module of claim 1, wherein an output of said harmonic generating crystal is about 430 nm.

11. The light source module of claim 1, wherein an output of said harmonic generating crystal is about 550 nm.

12. The light source module of claim 1, and further comprising a beam splitter in optical communication with said harmonic generating crystal and a sensor in optical communication with said beam splitter, said beam splitter being configured to direct a portion of an output of said harmonic generating crystal to said sensor.

13. A display system, comprising:
a controller;
at least one light source module including a laser configured to generate infrared light, a harmonic generating crystal in optical communication with said laser, said harmonic generating crystal being configured to produce a substantially full output when said laser is activated, and an actuator coupled to said harmonic generating crystal, said actuator being configured to apply a restoring force to said harmonic generating crystal in response to a change in length of said harmonic generating crystal; and
a light modulator assembly coupled to said light source.

14. The system of claim 13, wherein said at least one light source module is configured to generate blue light.

15. The system of claim 13, wherein said at least one light source module is configured to generate green light.

16. The system of claim 13, and further comprising a second light source module, said first light source module being configured to generate green light and said second light source module being configured to generate blue light.

17. The system of claim 13, wherein said controller is configured to provide a sweeping restoring force to said actuator and to determine an initial restoring force based on an output of said light source module in response to said sweeping restoring force.

18. The system of claim 17, wherein said controller is further configured to control said restoring force to maintain a maximum output of said light source module.

19. A method of generating light, comprising:
generating infrared laser light;
multiplying a frequency of said infrared laser light with a harmonic generating crystal, said harmonic generating crystal having a periodicity selected to provide a maximum output at an initial operating temperature; and
selectively providing a restoring force to maintain said periodicity.

20. The method of claim 19, wherein said harmonic generating crystal provides said maximum output when said infrared laser light is generated.

21. The method of claim 19, wherein selectively providing said restoring force includes selectively compressing said harmonic generating crystal.

22. The method of claim 19, wherein multiplying said frequency of said infrared laser light includes doubling a frequency of said infrared laser light.

23. The method of claim 19, and further comprising applying a periodically varying force in addition to said restoring force and monitoring an output of said harmonic generating crystal in response to said periodically varying force.

24. The method of claim 19, and further comprising increasing said restoring force when an output of said harmonic generating crystal increases in response to a periodic increase in said restoring force and decreasing said restoring force when said output increases in response to a periodic decrease in said restoring force.

25. A system, comprising:
means for generating infrared light;
means for multiplying a frequency of said infrared light; and
means for maintaining a periodicity of said means for multiplying said frequency.

26. The system of claim 25, and further comprising means for collimating an output of said means for generating infrared light.
